(19) United States
(12) Patent Application Publication
(10) Pub. No.: US 2021/0277611 A1
(43) Pub. Date: Sep. 9, 2021

(54) HEATED SCREED RAKING DEVICE AND METHOD FOR RAKING ASPHALT ON A PAVING SURFACE

(71) Applicant: Axenox, LLC, Powell, WY (US)

(72) Inventors: Stuart Anthony FROST, Powell, WY (US); David Michael FROST, JR., Powell, WY (US)

(21) Appl. No.: 17/207,383

(22) Filed: Mar. 19, 2021

Related U.S. Application Data
(60) Provisional application No. 62/987,215, filed on Mar. 9, 2020.

(51) Int. Cl. E01C 19/44; E04F 21/24; H05B 1/02

(52) U.S. Cl. CPC E01C 19/44; E04F 21/241; H05B 3/0014; E01C 2301/10; H05B 1/0227

(57) ABSTRACT

A hand-held screed rake and method for spreading paving material using the hand-held screed rake. The hand-held screed rake includes a screed head having a paving surface and a heating element coupled to the screed head and configured to heat the paving surface.

### RELATED APPLICATIONS

This application claims the benefit of U.S. Provisional Patent Application No. 62/987,215, filed Mar. 9, 2020, and hereby incorporates by reference herein the entire contents thereof.

### TECHNICAL FIELD

Aspects of the disclosure are directed to systems and methods for a heated hand-held screed raking device and a method for applying a paving material to a surface using the same.

### BACKGROUND

Screed rakes are typically used to apply a paving material such as asphalt, concrete, glue and/or other viscous materials to a surface. The paving material may typically be spread while the paving material is hot so that the paving material is pliable and minimally viscous.

Screed rakes may be made out of materials with high thermal conductivity, such as aluminum or a combination of aluminum and magnesium. Such rakes typically cool quickly as the hot paving material is spread along the surface. This can cause the paving material to stick to the screed rake, making it difficult to apply the paving material to the surface evenly and homogenously. Accordingly, it would be advantageous to enable application of the paving material with a screed rake adapted to prevent the paving material from sticking to the screed rake.

### SUMMARY

The following presents a simplified summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

According to some aspects, the present disclosure is directed to a hand-held screed rake including one or more heating elements positioned within a head of the hand-held screed rake and configured to heat portions of the head of the hand-held screed rake that contact the paving material to prevent the paving material from sticking to the head of the hand-held screed rake during a paving process.

According to some aspects, the present disclosure is directed to hand-held screed rake including a screed head having a paving surface and a heating element coupled to the screed head and configured to heat the paving surface. In some aspects, the heating element may be a first heating element. The hand-held screed rake may further include a dozer plate angled relative to the paving surface and a second heating element coupled to and configured to heat the dozer plate.

In some aspects, the present disclosure is directed to a method for paving a surface to be paved with a hand-held screed rake. The method includes actuating heating controls to command one or more heating elements coupled to a head of the hand-held screed rake to provide heat to the head of the hand-held screed rake. The method includes contacting paving material with the head of the hand-held screed rake. The method includes spreading, with the head of the hand-held screed rake, the paving material along surface to be paved.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 illustrates a side view of a hand-held screed rake according to an aspect of the disclosure;

FIG. 2 illustrates a cross-sectional view of the hand-held screed rake of FIG. 1 according to some aspects of the disclosure;

FIG. 3 illustrates an enlarged side view of a head of the hand-held screed rake of FIG. 1 with an end cap removed, according to an aspect of the disclosure;

FIG. 4 illustrates an enlarged side view of an attachment portion of the hand-held screed rake of FIG. 1, according to an aspect of the disclosure;

FIG. 5 illustrates a detail cross-sectional view of a handle of the screed rake of FIG. 1, taken along lines 5-5 of FIG. 1, according to an aspect of the disclosure;

FIG. 6 illustrates a bottom view of the head of the screed rake of FIG. 1, according to an aspect of the disclosure;

FIGS. 7A-7E illustrate exemplary patterns of a rake shoe of the screed rake of FIG. 1, according to an aspect of the disclosure; and

FIG. 8 illustrates the screed rake of FIG. 1 engaged with an operator, according to an aspect of the disclosure.

### DETAILED DESCRIPTION

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

For purposes of the disclosure, directional terms are expressed generally with relation to a standard frame of reference when the system and apparatus described herein are installed in an in-use orientation. In order to provide context to the current disclosure, a broad overview of the discovered deficiencies of various systems and an example implementation of the current disclosure and the advantages provided by the disclosure are described below. Further details of example implementations of the current disclosure are described in detail with reference to the figures below.

The present disclosure is related to heated hand-held rakes. In some aspects, the hand-held rake includes a head made of a thermally-conductive material such as aluminum or an aluminum alloy and one or more heating elements coupled to the head and configured to heat the head. The hand-held rake may comprise a screed rake, an asphalt lute, an asphalt rake, or a concrete float.

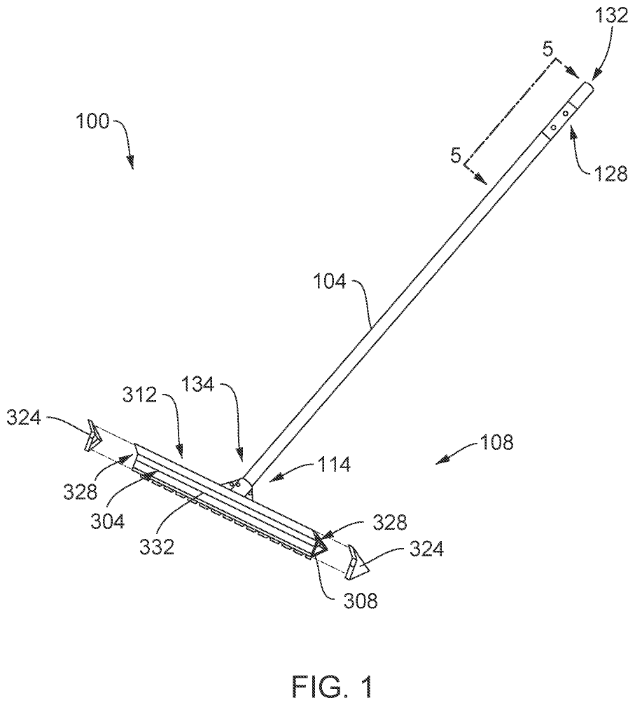

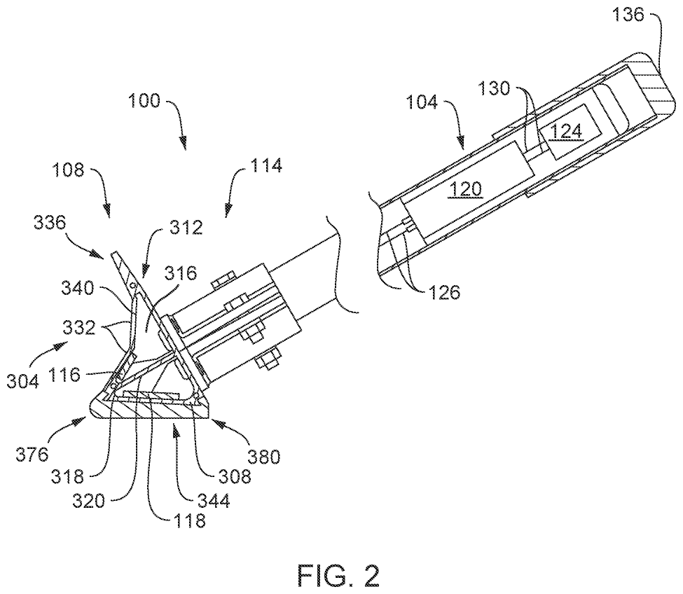

FIG. 1 illustrates a perspective view of a hand-held screed rake 100 according to an aspect of the present disclosure. FIG. 2 illustrates a cross-sectional view of the screed rake 100. The hand-held screed rake 100 may include a handle 104, a head 108, an attachment portion 114 configured to releasably couple the handle 104 to the head 108, and a heating system configured to heat the head 108. In some aspects, the handle 104 may be configured for the operator to use the screed rake 100 when the operator is standing. In some aspects, the handle 104 may be configured for the operator to use the screed rake 100 when the operator is kneeling or sitting on the floor.

The heating system may include one or more heating elements 116, 118 a battery 120, and heating controls 124. As is described in greater detail below, the heating elements 116, 118 may be coupled to portions the head 108 that contact paving material and are configured to heat the portions of the head 108 to prevent paving material from sticking to the head 108. In the illustrated disclosure, the heating system includes two heating elements 116, 118. In other aspects of the disclosure, the heating system may include more or fewer heating elements. For example, the heating system may include one of the heating elements 116, 118. The heating elements 116, 118 may include heat conductive electrical heating strips, heating pads, tubular heating elements, or silicone heating elements.

Wires 126 may couple the heating elements to the battery 120 so that the battery 120 may provide electrical power to the heating elements 116. In some aspects, the battery 120 may be a rechargeable battery. In some aspects, the battery 120 may be removable from the hand-held screed rake 100. The battery may be any number of rechargeable batteries well-known in the power tool or other industries (such as a rechargeable lithium-ion battery). The battery can be configured to constantly provide power to the heating elements and be shut off manually by the user, or a control circuit can be provided which sets a duty cycle based on a sensed temperature of the head 108. Wires 130 may couple the heating controls 124 to the battery 120 to allow an operator to control a temperature of the heating elements 116, 118 and/or control an amount of power provided to the heating elements 116, 118. The heating controls 124 may include an operator input/output (I/O) interface 128 positioned on the handle 104. The operator I/O interface 128 may allow the operator to actuate the heating elements 116, 118. In some aspects, the operator I/O interface 128 may include an indicator that notifies the operator when the heating elements 116, 118, the dozer plate 304, and/or the shoe plate 308 are hot enough for the paving material not to stick to the head 108 of the screed rake 100.

In some aspects, the heating controls 124 may be configured to heat the heating elements 116, 118 from an ambient temperature to a heating temperature that is high enough to prevent the paving material from sticking to the head 108 using the battery 120. In some aspects, the heating controls 124 may be configured to heat or preheat the heating elements 116, 118 while the hand-held screed rake 100 is plugged into a power source, such as a power supply on a vehicle or an electrical outlet in a building. In some aspects, preheating may include heating the head 108 or the heating elements 116, 118 from an ambient temperature to a temperature hot enough to prevent the paving material from sticking to the head 108. In some aspects, preheating may include heating the head 108 or the heating elements 116, 118 from an ambient temperature to a temperature between the ambient temperature and the temperature hot enough to prevent the paving material from sticking to the head 108. The heating controls 124 may then be configured to maintain the temperature of the heating elements 116, 118 at the temperature high enough to prevent asphalt from sticking to the head 108 using the battery 120. Such a configuration may extend the amount of time that the battery 120 can provide power to the heating elements 116, 118 by using the power from the battery 120 to maintain the temperature of the heating elements 116, 118 or heat the heating elements 116 from a temperature higher than the ambient temperature. In some aspects, the hand-held screed rake 100 may be operable while it is plugged into a power source on a building or a vehicle.

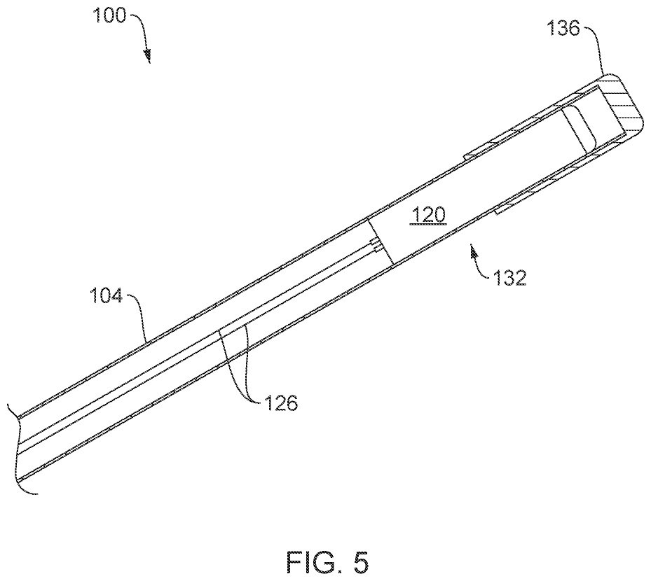

The handle 104 may have a first end 132 engageable by an operator and a second end 134 coupled to the head 108. As shown in FIG. 2, at least a portion of the handle 104 may be hollow such that the battery 120 and the heating controls 124 may be positioned within the handle 104 proximate the end 132 of the handle 104 engageable by the operator. The handle 104 may include an end cap 136 that may be removable to provide access to an interior of the handle 104. The operator may remove the end cap 136 to remove or replace the battery 120. In some aspects, the handle 104 and the end cap 136 may include a non-conductive, lightweight, and resilient material. FIG. 5 illustrates an aspect in which the battery 120 and the heating controls 124 are in the same element.

Referring now to FIGS. 1-3, the head 108 may include a dozer plate 304, a shoe plate 308, and a back plate 312. The dozer plate 304, the shoe plate 308, and the back plate 312 may define a cavity 316 therebetween. In the illustrated aspect of the disclosure, the dozer plate 304 and the shoe plate 308 may be oriented at an acute angle relative to each other, the shoe plate 308 and the back plate 312 may be oriented at an acute angle relative to each other, and the back plate 312 and the dozer plate 312 may be oriented at an acute angle relative to each other. In some aspects of the disclosure, a cross section of the cavity 316 may be substantially triangular. In some aspects of the disclosure, the cross section of the cavity 316 may be substantially shaped like an arrowhead. In some aspects, the head 108 has a hollow prism-like shape. A support spine 320 may extend between an edge 318 (formed by the dozer plate 304 and the shoe plate 308) and the back plate 312. End caps 324 (FIG. 1) may be removably coupled to ends 328 of the head 108 to provide access to the cavity 316. In some aspects, the end caps 324 may be substantially flat, as shown in FIGS. 1, 6, and 8C-8E. In some aspects, the end caps 324 may include protrusions 330 configured to align with the sides of the dozer plate 304 and prevent paving material from spilling out of the sides of the dozer plate 304. In some aspects, the head 108 may include a heat conductive material such as aluminum, titanium, or a mixture thereof. In some aspects, the head 108 may include another durable, heat conductive, lightweight material.

A front surface 332 of the dozer plate 304 may be a concave surface configured to engage a portion of the paving material and urge the paving material in front of and/or under (e.g., towards the surface being paved) the head 108. In some aspects, the front surface 332 of the dozer plate 304 may collect or retain a portion of the paving material against the front surface 332. The weight of this retained paving material may prevent the head 108 from lifting and/or rotating away from the surface to be paved during the paving process. A top portion 336 of the concave surface 332 may be oriented to prevent the paving material from spilling over the top of the head 108.

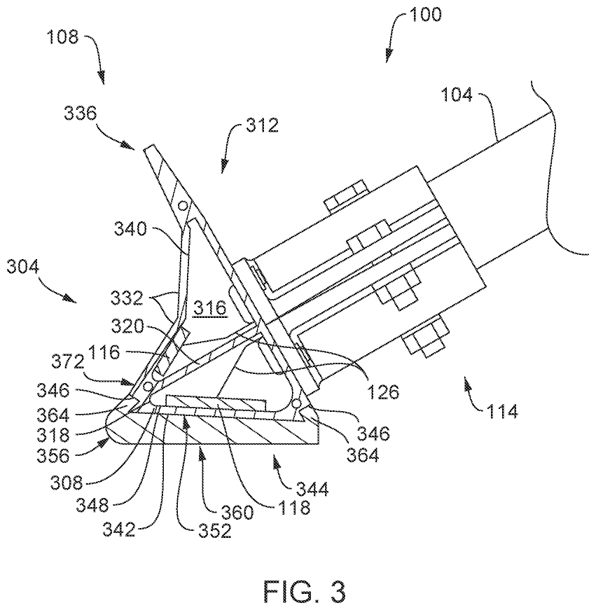

The dozer plate 304 may be angled relative to the shoe plate 308. A back surface 340 of the dozer plate 304 may form a wall of the cavity 316. One or more of the heating elements 116 may be engaged with the back surface 340 of the dozer plate 304. For example, as illustrated in FIGS. 2 and 3, the heating element 116 may be engaged with a portion of the back surface 340 proximate the edge 318. In other aspects of the disclosure, the heating element 116 may be positioned elsewhere on the back surface 240 of the dozer plate 304 or an additional heating element may be positioned adjacent the heating element 116 on the back surface 240. The heating element 116 may be configured to heat the dozer plate 304 to prevent paving material from sticking to the front surface 332 of the dozer plate 304.

The shoe plate 308 may be substantially planar. A bottom surface 342 of the shoe plate 308 may be configured to engage a rake shoe 344. The edges of the bottom surface 342 may include cutout portions 346 that extend along the length of the shoe plate 308. The cutout portions 346 may be configured to engage the rake shoe 344. An upper surface 348 of the shoe plate 308 may form a wall of the cavity 316. One or more of the heating elements 118 may be engaged with the upper surface 348 of the shoe plate 308. The heating element 118 may be configured to heat the shoe plate 308 and the rake shoe 344 to prevent paving material from sticking to the rake shoe 344. In operation, the user may orient the shoe plate 308 (and therefore the rake shoe 344) at a desired angle relative to the surface being paved to apply the paving material at a specific thickness by manipulating the handle.

The rake shoe 344 may include an upper surface 352, a leading surface 356, and a lower or paving surface 360. The upper surface 352 may be substantially planar and configured to engage the upper surface 348 of the shoe plate 308. Heat generated by the heating element 118 may radiate through the shoe plate 208 and through the shoe plate 334, thereby heating the paving surface 360 and preventing paving material from sticking to the paving surface 360. In some aspects, the rake shoe 344 may include a heat conductive material such as aluminum, titanium, or a mixture thereof. In some aspects, the rake shoe 344 may include another durable, heat conductive, lightweight material.

The rake shoe 344 may include side portions 364 that extend above the upper surface 348 and form acute angles relative to the upper surface 352. The side portions 364 and the upper surface 348 may cooperatively form tracks configured to slidingly receive the cutout portions 346 of the shoe plate 308 therein.

The leading surface 356 may be curved. A first portion 368 of the leading surface 356 may be configured to abut a lower end 372 of the dozer plate 304 and may be aligned with the concave surface 332. The leading surface 356 may curve from the lower end 372 of the dozer plate 304 to the paving surface 360 of the rake shoe 344. The curvature of the leading surface 356 may be configured to guide the paving material from the lower portion of the concave surface 332 of the of the dozer plate 304 to the paving surface 360 of the rake shoe 344.

The paving surface 360 may be configured to engage the paving material and spread the paving material across the surface to be paved. The heat from the heating element 118 may prevent paving material from sticking to the paving surface 360 of the rake shoe 344. In some aspects, the paving surface 360 may be smooth (e.g., may not have a texture or geometric pattern), as shown in FIGS. 2-3 and 7E. In some aspects, the paving surface 360 may have a texture or a geometric pattern, as shown in FIGS. 1, 6, and 7A-7D.

In some aspects of the disclosure, the rake shoe 344 may be removable from the shoe plate 308. In such aspects, the rake shoe 344 may be coupled to the head 108 by features such as pressurizing or impinging lips or removable tracks on the rake shoe 344, clips, straps, threaded connectors, toggles, pins, or other devices. In other aspects of the disclosure, the shoe plate 308 may include the features of the rake shoe 344.

The back plate 312 may be substantially planar. A portion of the back plate 312 may form a wall of the cavity 316. The handle 104 may be coupled to the head 108 via the back plate 312 as described in greater detail below.

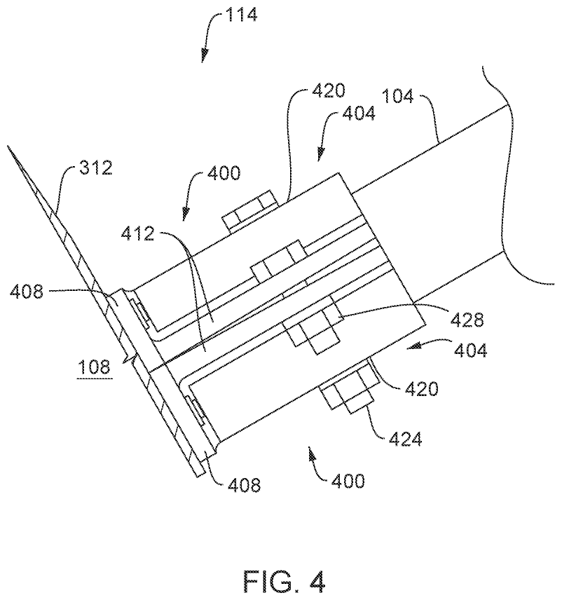

FIG. 4 illustrates an enlarged side view of the attachment portion 114. The attachment portion may include two opposed flanges 400 that are spaced apart to receive the handle 104 therebetween. Each of the flanges 400 may include a head engagement portion 408 and a handle engagement portion 404. The head engagement portion 408 and the handle engagement portion 404 may be perpendicular to each other. The head engagement portion 408 may be substantially planar and may be coupled to the back plate 312.

The handle engagement portion 408 includes two spaced apart flanges 412 and a curved wall 420 configured to receive a portion of the handle 104 therebetween. The handle 104 may be inserted between the curved portions 420 of both flanges 400. Bolts 428 extending through holes in the flanges 412 may then be tightened to securely grip the handle 104. The handle 104 may be secured to the curved portions 420 of both flanges 400 by a bolt 424 inserted through holes in the curved portions 420 and the handle 104.

438 may include nuts and bolts, clips, cotter pins, a ring with a tightening bolt, and so forth.

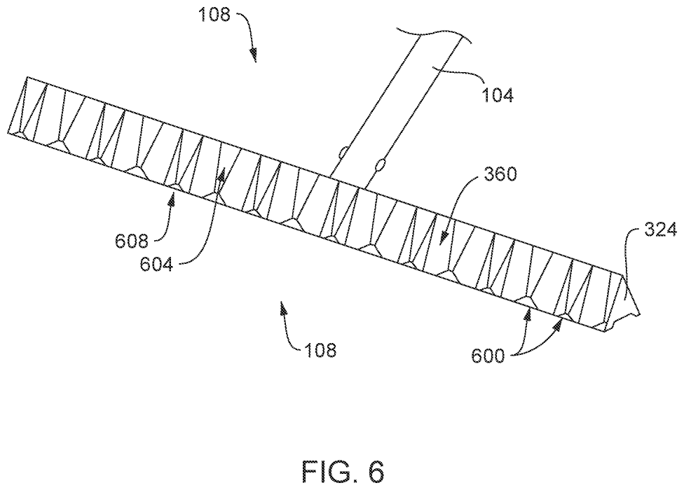

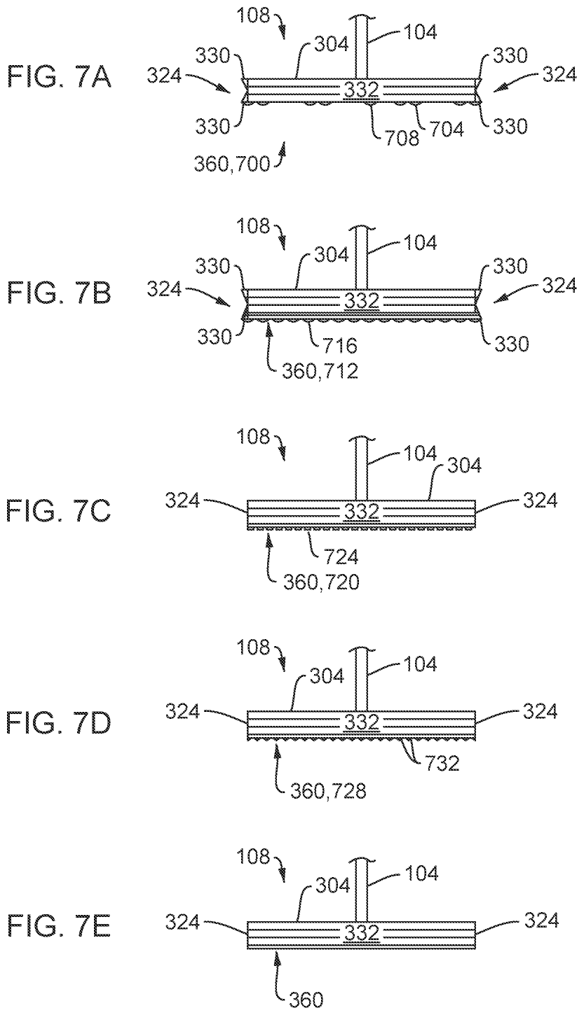

FIGS. 6 and 7A-D illustrate embodiments in which the paving surface 360 of the rake shoe 344 includes a textured pattern. A textured pattern may spread the paving material across the surface to be paved in a more homogenous manner (e.g., less clumps, patches with mostly coarse or fine particles or aggregates of paving material, and so forth) by allowing both large and small aggregates of the paving material to slide under the paving surface 360 of the rake shoe. In some aspects, the textured pattern may include one repeating pattern feature, as illustrated in FIGS. 7C and 7D. In some aspects, the textured pattern may include two or more different repeating pattern features. In some aspects, a height and/or an amplitude of the textured pattern may decrease from a leading edge 376 of the paving surface 360 to a trailing edge 380 of the paving surface 360. As used herein, the phrase “leading edge” refers to the first portion of the paving surface 360 that contacts the paving material as the operator spreads the paving material with the hand-held screed rake 100. The phrase “trailing edge” refers to the last portion of the paving surface 360 that contacts the paving material as the operator spreads the paving material with the hand-held screed rake 100.

FIG. 6 illustrates a bottom view of the screed rake 100 including a textured pattern 600 on the paving surface 360. The textured pattern 600 includes an undulating surface having a first repeating feature 604 and a second repeating feature 608 that are in a tapered diamond or pyramidal shape. This shape can be presented as a single pattern, or an offset of the repeating pattern in different rows along the paving direction of the paving surface 360.

FIG. 7A illustrates a front view the screed rake 100 including a textured pattern 700 on the paving surface 360. The textured pattern 700 is a waveform pattern that may include a first repeating feature 704 and a second repeating feature 708.

FIG. 7B illustrates a front view the screed rake 100 including a textured pattern 712 on the paving surface 360. The textured pattern 712 includes a repeating feature 716. In the aspect illustrated in FIG. 7B, the repeating feature 716 is a ridge having an arcuate cross-section.

FIG. 7C illustrates a front view the screed rake 100 including a textured pattern 720 on the paving surface 360. The textured pattern 720 includes a repeating feature 724. In the aspect illustrated in FIG. 7C, the repeating feature 724 is a ridge having a square or block-shaped cross-section.

FIG. 7D illustrates a front view the screed rake 100 including a textured pattern 728 on the paving surface 360. The textured pattern 728 includes a repeating feature 732. In the aspect illustrated in FIG. 7D, the repeating feature 732 is a ridge having a triangular or v-shaped cross-section.

FIG. 7E illustrates a front view the screed rake 100 having a smooth paving surface 360.

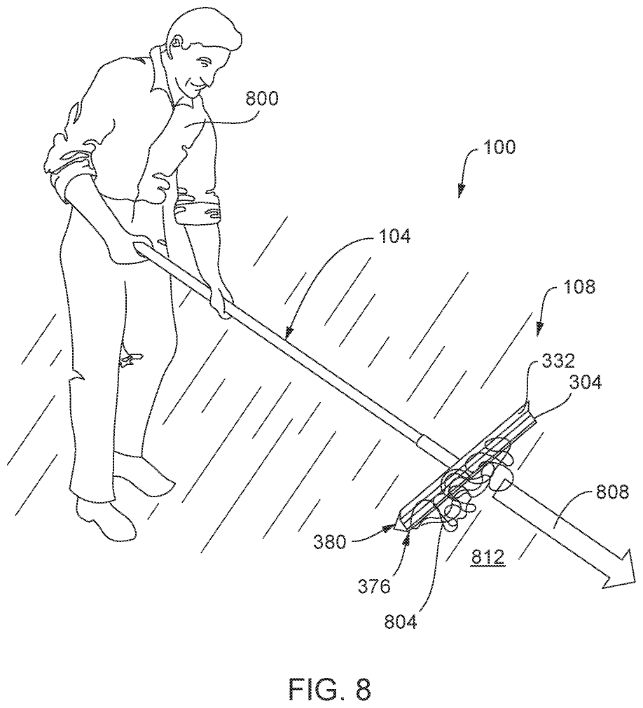

FIG. 8 illustrates an operator 800 using the screed rake 100 to spread paving material 804 in a paving direction 808 across a surface to be paved 812. Before beginning to spread the paving material 804, the operator 800 may operate the heating controls 124 of the heating system to command the battery 120 to provide power to the heating elements 116, 118. The heating element 116 may heat the dozer plate 304 and the heating element 118 may heat the shoe plate 308 and the rake shoe 344, thereby preventing paving material from sticking to the head 108 of the screed rake 100.

The operator 800 may then position the screed rake 100 so that the head 108 of the screed rake 100 is behind a pile of the paving material 804, as illustrated in FIG. 8. The operator 800 may then push the screed rake 100 forward in the paving direction 808 along a surface to be paved 818, engaging the front surface 332 of the dozer plate 304 with the pile of the paving material 804. As the operator 800 pushes the screed rake in the paving direction 808, a first portion of the paving material 804 may accumulate in the concave front surface 332 of the dozer plate 304 and move with the head 108 in the paving direction 808 as the operator actuates the screed rake 100. The weight of this accumulated paving material 804 may prevent the head 108 from lifting and/or rotating away from the surface to be paved 812 during the paving process.

A portion of the second portion of the paving material 804 in the pile paving material 804 and/or in the paving material 804 in the concave portion of the front surface 332 may travel along the leading edge 376 of the rake shoe 344 and slide under the rake shoe 344. The paving material 804 may slide between the paving surface 360 of the rake shoe 344 and the surface to be paved 818. In aspects in which the paving surface 360 includes a textured pattern, the textured pattern may facilitate movement of both large, medium, and small clumps of paving material 804 to slide under the paving surface 360 of the rake shoe 344 and be spread along the surface to be paved 812 in a substantially uniform manner.

As the operator 800 spreads the paving material 804 across the surface to be paved 818, the operator 800 may orient the rake shoe 344 and/or the shoe plate 308 at a desired angle. For example, the operator 800 may rotate the handle 104 of the screed rake 100 relative to the surface to be paved 812 to position the rake shoe 344 and/or the shoe plate 308 at the desired angle. The curvature of the leading surface 356 of the rake shoe 344 may allow the operator 800 to smoothly change the angle of the rake shoe 344 and/or the shoe plate 308 as desired during the paving process. Changing the angle of the rake shoe 344 and/or the shoe plate 308 allows the operator to adjust the grade and compaction of the paving material during the paving process.

When the operator 800 determines that the battery 120 may need to be recharged or replaced, the operator 800 may remove the end cap 136 of the handle 104 to access the hollow portion of the handle 104. The operator 800 may then remove the battery 120 from the handle to recharge or replace the battery 120. In some aspects of the disclosure, the operator 800 may recharge the battery 120 without removing the battery 120 from the handle 104 using an appropriate charging adapter.

The various components described herein may be constructed of such suitable materials and by appropriate processes for the component described. Such appropriate processes may include, for example, molding, dipping forging, casting, etc., depending on the materials used, as are known in the art.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

What is claimed is:

1. A hand-held screed rake comprising:
a screed head having a paving surface; and
a heating element coupled to the screed head and configured to heat the paving surface.

2. The hand-held screed rake of claim 1, wherein the heating element is a first heating element, and the hand-held screed rake further comprises:
a dozer plate angled relative to the paving surface; and
a second heating element coupled to and configured to heat the dozer plate.

3. The hand-held screed rake of claim 2, further comprising a back plate coupled to the paving surface and the dozer plate, the back plate, the paving surface, and the dozer plate defining a cavity therebetween, and wherein the first and second heating elements are within the cavity.

4. The hand-held screed rake of claim 1, wherein the heating element is an electrical heating strip, heating pad, a tubular heating element, or a silicone heating element.

5. The hand-held screed rake of claim 1, further comprising a handle removably coupled to the screed head

6. The hand-held screed rake of claim 5, wherein the handle includes a rechargeable battery coupled to the heating element.

7. The hand-held screed rake of claim 6, wherein the handle further includes heater controls configured to control a temperature of the heating element.

8. The hand-held screed rake of claim 6, wherein the heating controls are configured to maintain a temperature of the heating element using the battery.

9. The hand-held screed rake of claim 6, wherein the heating controls are configured to heat the heating element from an ambient temperature to a temperature configured to prevent paving material from sticking to the screed head using power from a power supply.

10. The hand-held screed rake of claim 9, wherein the heating controls are configured to maintain a temperature of the heating element using the battery.

11. The hand-held screed rake of claim 6, wherein the heating controls are configured to heat the heating element from an ambient temperature between the ambient temperature and a temperature configured to prevent paving material from sticking to the screed head using power from a power source in a building or a vehicle.

12. The hand-held screed rake of claim 1, wherein the paving surface comprises a shoe plate and a rake shoe removably coupled to the shoe plate.

13. The hand-held screed rake of claim 1, wherein the paving surface comprises a textured pattern.

14. The hand-held screed rake of claim 12, wherein the textured pattern comprises a waveform pattern, an arcuate pattern, a v-shaped pattern, or a block-shaped pattern.

15. A method for paving a surface to be paved with a hand-held screed rake comprising:
actuating heating controls to command one or more heating elements coupled to a head of the hand-held screed rake to provide heat to the head of the hand-held screed rake;
contacting paving material with the head of the hand-held screed rake; and
spreading, with the head of the hand-held screed rake, the paving material along surface to be paved.
